(19) United States
(12) Patent Application Publication
(10) Pub. No.: US 2013/0316633 A1
(43) Pub. Date: Nov. 28, 2013

(54) SYSTEM AND METHOD FOR PREVENTING INFLOW OF EXHAUST GAS FOR VEHICLE

(71) Applicants: HYUNDAI MOTOR COMPANY, Seoul (KR); KIA MOTORS CORP., Seoul (KR)

(72) Inventors: Moo Yong Kim, Suwon-si (KR); Jun Kyu Park, Hwaseong-si (KR); Dong Won Yeon, Hwaseong-si (KR)

(73) Assignees: Kia Motors Corp., Seoul (KR); Hyundai Motor Company, Seoul (KR)

(21) Appl. No.: 13/667,798

(22) Filed: Nov. 2, 2012

(30) Foreign Application Priority Data
May 25, 2012 (KR) 10-2012-0055782

(51) Int. Cl. B60H 1/24

(52) U.S. Cl. 454/75

(57) ABSTRACT

A system for preventing inflow of exhaust gas for a vehicle, may include an inside/outside air door provided in an air conditioning device of the vehicle and controlling an amount of outside air introduced into an inside of the vehicle, an outside-air temperature sensor measuring a temperature of the outside air of the vehicle, a temperature control door disposed inside the air conditioning device of the vehicle and controlling a temperature of air discharged to the inside of the vehicle, and a control unit controlling the inside/outside air door to cause an amount of the outside air to be introduced to the inside when a vehicle speed may be equal to or larger than a predetermined speed, wherein the control unit controls the temperature control door to control the temperature of the air discharged to the inside when the temperature of the outside air deviates from a predetermined temperature range.

### CROSS-REFERENCE TO RELATED APPLICATION

The present application claims priority to Korean Patent Application No. 10-2012-0055782, filed on May 25, 2012, the entire contents of which is incorporated herein for all purposes by this reference.

### BACKGROUND OF THE INVENTION

1. Field of the Invention

The present invention relates to a system and method for preventing inflow of exhaust gas for a vehicle, which resolves a difference in pressure between the inside and outside of a vehicle when it is being driven at high speed, and simultaneously controls the temperature of air discharged to the inside of the vehicle, thus preventing performance of heating or cooling the inside from being degraded and maintaining the passengers comfortable.

2. Description of Related Art

Generally, a vehicle is manufactured to block the inflow of outside air into the inside thereof. However, some air may flow in and out of the vehicle because of manufacturing error or assembly limitations. In this case, if the vehicle drives at high speed, pressure of the inside is reduced, so that exhaust gas of the vehicle may reenter the inside of the vehicle due to the difference in pressure between the inside and outside of the vehicle.

To be more specific, this reentry does not cause a problem if the outside air is introduced by controlling an inside/outside air door of an air conditioning device when the vehicle is being driven at high speed because the pressure drop in the vehicle is reduced by the outside air. However, in the case of blocking the introduction of the outside air and circulating inside air, the pressure in the vehicle is lowered, so that contaminated air from outside or the exhaust gas of the vehicle has an increased tendency to reenter the vehicle.

Meanwhile, in order to solve the problem, the outside air flows into the inside of the vehicle to resolve the difference in pressure. However, if the outside air is introduced in an extremely hot or cold season, the hot or cold air of the outside changes the inside temperature, so that the performance of heating or cooling the inside is degraded, and thereby a driver may feel unpleasant.

Therefore, a technology is required to introduce the outside air by the operation of an air conditioning system when the vehicle is being driven at high speed, thus overcoming a difference in pressure between the inside and outside of the vehicle, and simultaneously to control the temperature of the introduced outside air and then discharge the air to the inside, thus preventing the reentry of the exhaust gas and keeping the inside environment pleasant.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a system and method for preventing the inflow of exhaust gas for a vehicle, which prevents the reentry of the exhaust gas into the inside due to a drop in the inside pressure of the vehicle when it is being driven at high speed, and simultaneously controls the temperature of outside air and then discharges the air to the inside, thus improving the performance of heating or cooling the inside and keeping the inside air pleasant.

In an aspect of the present invention, a system for preventing inflow of exhaust gas for a vehicle, may include an inside/outside air door provided in an air conditioning device of the vehicle and controlling an amount of outside air introduced into an inside of the vehicle, an outside-air temperature sensor measuring a temperature of the outside air of the vehicle, a temperature control door disposed inside the air conditioning device of the vehicle and controlling a temperature of air discharged to the inside of the vehicle, and a control unit controlling the inside/outside air door to cause an amount of the outside air to be introduced to the inside when a vehicle speed is equal to or larger than a predetermined speed, wherein the control unit controls the temperature control door to control the temperature of the air discharged to the inside when the temperature of the outside air deviates from a predetermined temperature range.

The temperature control door is disposed between a heater and an air conditioner and selectively diverts the air introduced to the air conditioner to the heater.

A blower is disposed to fluid-communicate the outside air to the air conditioner.

The system may further include a blower disposed inside the air conditioning device and controlling an amount of the air discharged to the inside of the vehicle, wherein the control unit controls the blower when the vehicle speed is equal to or above the predetermined speed or the temperature of the outside air deviates from the predetermined temperature range, thus increasing the amount of the air discharged to the inside.

The control unit controls the temperature control door when the temperature of the outside air is below the predetermined temperature range, thus increasing the temperature of the air discharged to the inside, the control unit reducing the temperature of the air discharged to the inside when the temperature of the outside air is above the predetermined temperature range.

The control unit controls the temperature control door to guide the outside air to pass through the heater when the temperature of the outside air is below the predetermined temperature range, and the control unit controls the temperature control door to guide the outside air to pass through the air conditioner when the temperature of the outside air is above the predetermined temperature range.

The control unit controls the inside/outside air door such that a larger amount of the outside air is introduced when an open part of the vehicle is tilted or opened, as compared to a case where the open part is closed.

In another aspect of the present invention, a method for preventing inflow of exhaust gas for a vehicle, may include a) detecting a vehicle speed, b) introducing an increased amount of outside air by controlling an inside/outside air door in an air conditioning device of the vehicle when the vehicle speed is equal to or above a predetermined speed, c) measuring a temperature of the outside air of the vehicle, and d) controlling a temperature of air discharged to an inside by controlling a temperature control door in the air conditioning device of the vehicle when the temperature of the outside air of the vehicle deviates from a predetermined temperature range.

The b) step may further include sensing whether an open part of the vehicle is tilted or opened, and introducing a larger amount of outside air than that of b) step, when the open part is tilted or opened.

After c) step, the method may further include increasing an amount of air discharged to the inside by controlling a blower in the air conditioning device of the vehicle when the temperature of the outside air of the vehicle deviates from the predetermined temperature range.

The d) step may include increasing the temperature of the air discharged to the inside by controlling the temperature control door when the temperature of the outside air is above the predetermined temperature range, and reducing the temperature of the air discharged to the inside when the temperature of the outside air is below the predetermined temperature range.

The d) step may include increasing the temperature of the air discharged to the inside by controlling the temperature control door to guide the outside air to pass through the air conditioner when the temperature of the outside air is above the predetermined temperature range, and reducing the temperature of the air discharged to the inside air by controlling the temperature control door to pass through a heater when the temperature of the outside air is below the predetermined temperature range.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a configuration of a system for preventing inflow of exhaust gas for a vehicle, in accordance with an exemplary embodiment of the present invention.

FIG. 2 is a view showing a flow of outside air introduced through an inside/outside air door of the system for preventing the inflow of exhaust gas of FIG. 1.

FIG. 3 is a view showing an operating state of a blower of the system for preventing the inflow of exhaust gas of FIG. 1.

FIG. 4 is a view showing an operation wherein a temperature of air discharged to an inside is increased by controlling a temperature control door of the system for preventing the inflow of exhaust gas of FIG. 1.

FIG. 5 is a view showing an operation wherein the temperature of the air discharged to the inside is reduced by controlling the temperature control door of the system for preventing the inflow of exhaust gas of FIG. 1.

FIG. 6 is a flow chart showing a method for preventing inflow of exhaust gas for a vehicle, in accordance with an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, a system and method for preventing the inflow of exhaust gas for a vehicle according to the preferred embodiment of the present invention will be described with reference to the accompanying drawings.

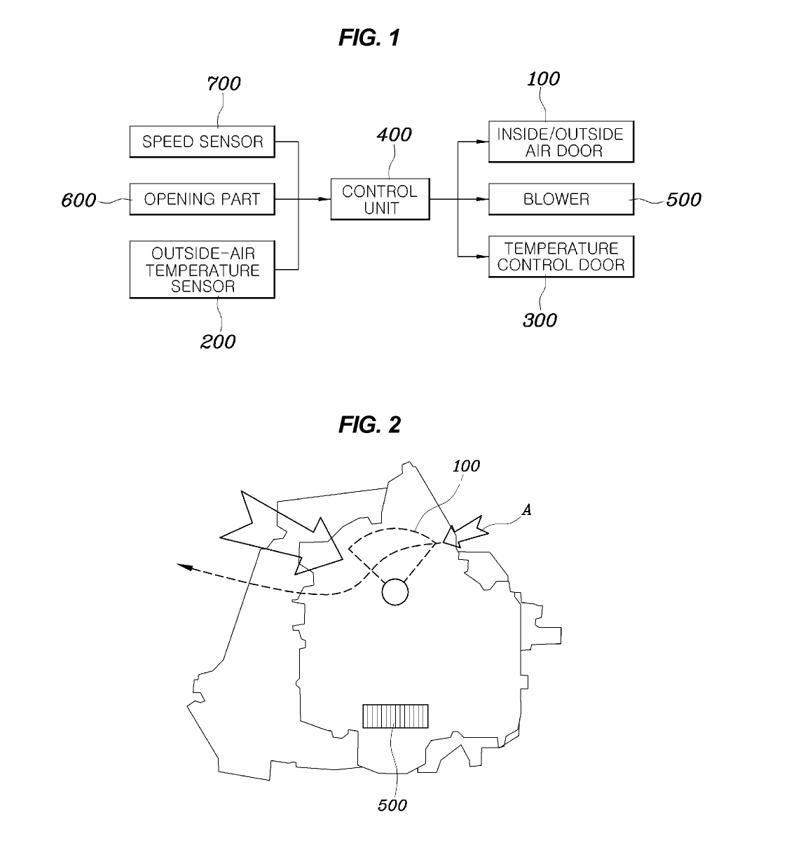

FIG. 1 is a view showing a configuration of a system for preventing inflow of exhaust gas for a vehicle, in accordance with an exemplary embodiment of the present invention. The system for preventing the inflow of the exhaust gas for the vehicle according to an exemplary embodiment of the present invention includes an inside/outside air door 100 that is provided in an air conditioning device of the vehicle to control the amount of outside air that is introduced into the inside. An outside-air temperature sensor 200 measures the temperature of the outside air of the vehicle. A temperature control door 300 of the air conditioning device of the vehicle controls the temperature of air discharged to the inside of the vehicle. A control unit 400 controls the inside/outside air door 100 to cause a larger amount of the outside air to be introduced when the vehicle speed is a predetermined speed or more, and controls the temperature control door 300 to control the temperature of the air discharged to the inside when the temperature of the outside air deviates from a predetermined temperature range.

As shown in the drawing, according to an exemplary embodiment of the present invention, when the vehicle speed is the predetermined speed or more, the inside/outside air door 100 is controlled to allow an increased amount of outside air A to be introduced into the vehicle. Meanwhile, when the temperature of the outside air A deviates from the predetermined temperature range, the temperature control door 300 is controlled to control the temperature of the air discharged to the inside. Thereby, this system resolves a difference in pressure between the inside and outside of the vehicle when it is being driven at high speed, and maintains the inside temperature, thus maintaining or enhancing the performance of heating or cooling the inside.

In the context of this invention, the predetermined temperature range may be one within which there is no change in the inside temperature, and is a temperature which does not give a driver an unpleasant feeling so that he or she does not feel too cold or hot in an extremely cold or hot season.

Meanwhile, under the control of the present invention, the inside temperature may vary regardless of the driver's intention. Hence, the temperature control door 300 is controlled to receive a set temperature and to control the temperature of the air discharged to the inside, when the driver sets the temperature of the air discharged to the inside.

To be more specific, the vehicle is provided with a speed sensor 700 to detect the vehicle speed. When it is determined that the vehicle speed detected by the speed sensor 700 is a predetermined speed or more, the control unit 400 opens the inside/outside air door 100 in a first stage to introduce an increased amount of outside air A.

The first stage opening of the inside/outside air door 100 will be described by way of example. The first stage opening of the inside/outside air door 100 is to open the inside/outside air door 100 by 10% in a direction of introducing the outside air so as to increase the amount of introduced outside air A. The inside/outside air door 100 is opened by 10% in the direction of introducing the outside air. However, if the inside/outside air door 100 is opened by 0% to block the introduction of the outside air or is partially opened by 10% or less, the inside/outside air door 100 is preferably controlled to be opened by 10%. Meanwhile, when the inside/outside air door 100 is opened by 10% or more, it may persistently maintain its state.

The reason why the outside air is introduced depending on the vehicle speed is as follows. When a general vehicle is being driven at high speed, the pressure of the inside becomes lower than that of the outside, so that the exhaust gas emitted from the vehicle reenters the inside of the vehicle. Thereby, when the vehicle speed detected by the speed sensor 700 is a speed that causes there to be a difference in pressure between the inside and outside of the vehicle, the inside/outside air door 100 of the air conditioning device is controlled to introduce an increased amount of outside air A, thus increasing the inside pressure and resolving the difference in pressure between the inside and outside.

Meanwhile, if the vehicle speed detected by the speed sensor 700 is the predetermined speed or more, the inside/outside air door 100 is controlled to be opened to the first stage, thus introducing an increased amount of outside air A. If the temperature of the outside air A deviates from the predetermined temperature range, the temperature control door 300 is controlled to control the temperature of the air discharged to the inside.

Controlling the temperature of the air discharged to the inside will now be described in detail. FIG. 2 is a view showing the flow of outside air A introduced through the inside/outside air door 100 of the system for preventing inflow of exhaust gas of FIG. 1. If the inside/outside air door 100 is controlled to introduce the outside air A, the outside air A is directly discharged to the inside.

However, if the outside air A is introduced without any treatment in an extremely cold or hot season, cold or hot air outside the vehicle is discharged to the inside without having been processed, so that the performance of cooling or heating the inside is degraded and the inside temperature changes, resulting in the driver feeling unpleasant.

Therefore, if the temperature of the introduced outside air A is sensed and this sensed temperature deviates from the predetermined temperature range, the outside air is discharged to the inside by controlling the temperature control door 300, thus resolving the difference in pressure between the inside and outside of the vehicle and simultaneously improving the performance of heating or cooling the inside, thereby essentially preventing a driver from feeling unpleasant due to a change in temperature.

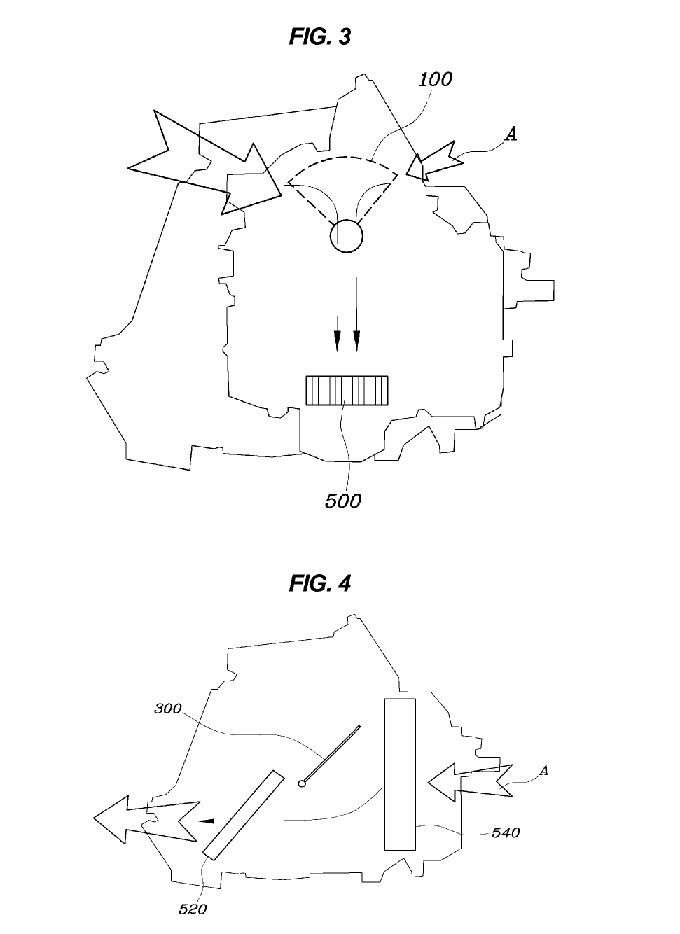

FIG. 3 is a view showing an operating state of a blower 500 of the system for preventing the inflow of exhaust gas of FIG. 1. The system further includes the blower 500 to control the amount of air discharged to the inside of the vehicle. If the vehicle speed is the predetermined speed or more and the temperature of the outside air A deviates from the predetermined temperature range, the control unit 400 controls the blower 500 to increase the amount of the air discharged to the inside.

As such, when the blower 500 of the air conditioning device of the vehicle is operated, the outside air A introduced through the inside/outside air door 100 flows into a heater unit 520 or an air conditioner unit 540 of the air conditioning device, thus preventing the introduced outside air A from being discharged to the inside without having been processed.

Further, if there is a large difference in temperature between the inside and outside of the vehicle, such as in an extremely cold or hot season, the extent to which the blower 500 is operated is increased, so that the amount of the air flowing into the heater unit 520 or the air conditioner unit 540 increases and thereby the inside temperature is controlled or maintained.

Controlling the temperature of the air discharged to the inside will now be described in detail. When the temperature of the outside air A is above the predetermined temperature range, the control unit 400 controls the temperature control door 300 to increase the temperature of the air discharged to the inside. In contrast, when the temperature of the outside air A is below the predetermined temperature range, the temperature of the air discharged to the inside is reduced.

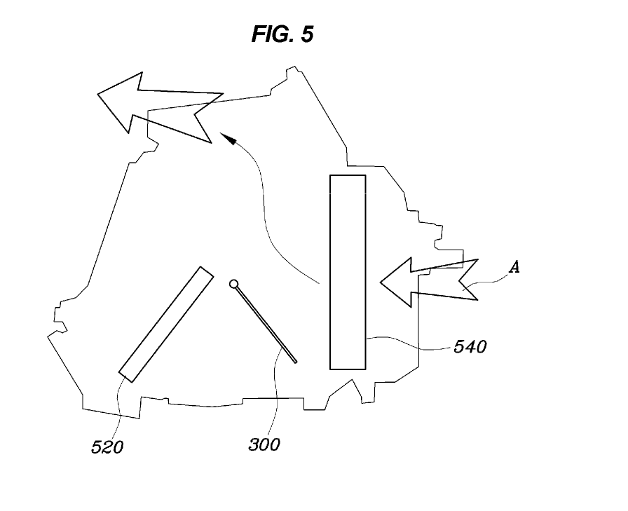

FIG. 4 is a view showing an operation wherein the temperature of the air discharged to the inside is increased by controlling the temperature control door 300 of the system for preventing inflow of exhaust gas of FIG. 1. If the temperature of the introduced outside air A is below the predetermined temperature range, the temperature control door 300 is controlled to cause the air introduced by the blower 500 to pass through the heater unit 520, so that the temperature of the air discharged to the inside is increased and thereby warm air is discharged to the inside.

On the other hand, FIG. 5 is a view showing an operation wherein the temperature of the air discharged to the inside is reduced by controlling the temperature control door 300 of the system for preventing inflow of exhaust gas of FIG. 1. If the temperature of the outside air A is above the predetermined temperature range, the temperature control door 300 is controlled to cause the air introduced by the blower 500 to pass through the air conditioner unit 540, so that the temperature of the air discharged to the inside is reduced and thereby cold air is discharged to the inside.

The control unit 400 controls to open the inside/outside air door 100 in a second stage, so that a larger amount of outside air A is introduced in the case where the open part 600 of the vehicle is tilted or opened, as compared to a case where the open part 600 is closed. Here, the open part 600 includes a window or a sunroof of the vehicle, and refers to a part that permits the air to flow in and out of the vehicle.

Generally, when the vehicle drives at high speed and the open part 600 of the vehicle is opened or tilted, for example when the window is partially opened or the sunroof is tilted, the inside pressure rapidly escapes to the outside of the vehicle that is lower in pressure.

Thus, when the open part 600 including the window or the sunroof is tilted or opened, the inside/outside air door 100 is controlled to be opened in the second stage that permits the introduction of a larger amount of outside air as compared to the first stage, thus replenishing the inside pressure, and rapidly resolving the difference in pressure between the inside and the outside.

Here, the opening of the inside/outside air door 100 in the second stage will be described by way of example. The opening of the inside/outside air door 100 in the second stage is to open the inside/outside air door 100 by 20%, thus allowing a larger amount of outside air A to be introduced as compared to the amount of the outside air A when the inside/outside air door 100 is opened in the first stage. The inside/outside air door 100 is opened by 20% in the direction of introducing the outside air. However, if the inside/outside air door 100 is opened by 10% as in the first-stage opening state or is partially opened by 20% or less, the door is preferably controlled to be opened by 20%. Meanwhile, when the inside/outside air door 100 is opened by 20% or more, it may persistently maintain its state.

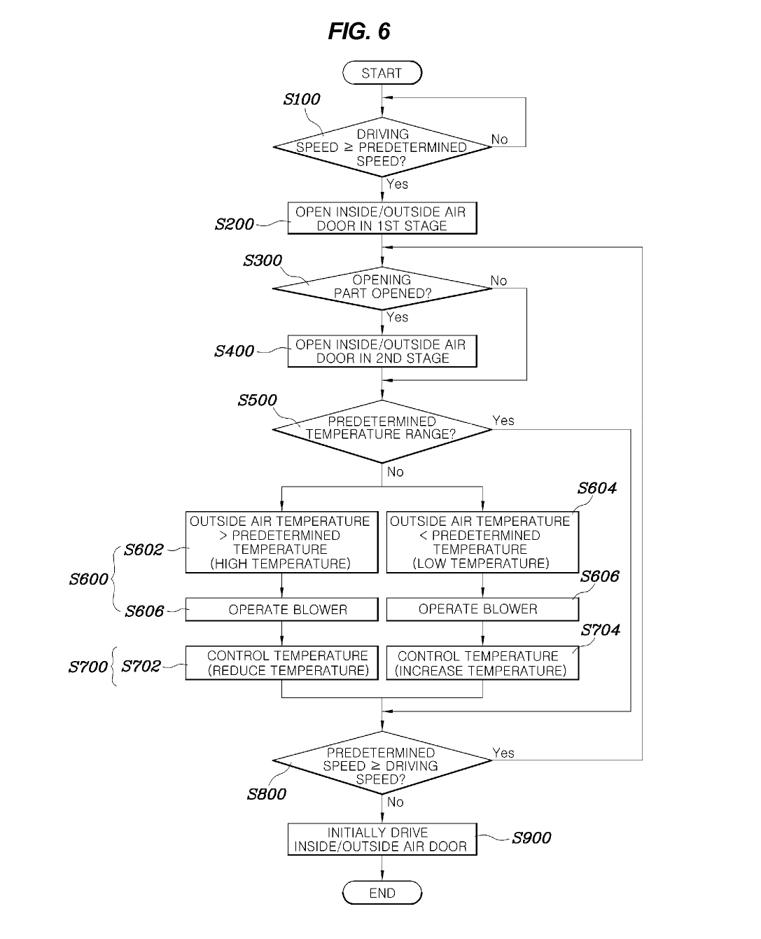

FIG. 6 is a flow chart showing a method for preventing inflow of exhaust gas for a vehicle, in accordance with an exemplary embodiment of the present invention. The method for preventing inflow of exhaust gas for a vehicle according to an exemplary embodiment of the present invention includes a speed detection step S100 of detecting a vehicle speed, an outside-air introducing step S200 of introducing an increased amount of outside air by controlling an inside/outside air door of an air conditioning device of the vehicle when the vehicle speed is a predetermined speed or more, a temperature measuring step S500 of measuring a temperature of the outside air of the vehicle, and a temperature control step S700 of controlling a temperature of air discharged to the inside by controlling a temperature control door of the air conditioning device of the vehicle when the temperature of the outside air of the vehicle deviates from a predetermined temperature range.

The outside-air introducing step S200 further includes an opening-part sensing step S300 of sensing whether an open part of the vehicle is tilted or opened, and an outside-air introduction increasing step S400 of introducing a larger amount of outside air than that of the opening-part sensing step, when the open part is tilted or opened.

Here, the outside-air introducing step S200 opens the inside/outside air door in the first stage, and opens the inside/outside air door in the second stage, at the outside-air introduction increasing step S400, if the open part of the vehicle is tilted or opened. The opening state of the inside/outside air door will be described in detail. At the outside-air introducing step S200, if the vehicle speed is a predetermined speed or more, the initial inside/outside air door is opened in the first stage to introduce an increased amount of outside air, thus resolving a difference in pressure between the inside and outside of the vehicle.

However, if the vehicle speed is the predetermined speed or more and the open part 600 is tilted or opened, the inside pressure rapidly escapes to the outside of the vehicle that is lower in pressure. Hence, the inside/outside air door is opened in the second stage to permit the introduction of a larger amount of outside air as compared to the case of opening the inside/outside air door in the first stage, thus replenishing a deficient inside pressure.

That is, when the vehicle is being driven at high speed and the open part 600 of the vehicle is opened or tilted, the inside pressure rapidly escapes to the outside of the vehicle that is lower in pressure. Hence, the inside/outside air door is controlled to be opened in the second stage at the opening-part sensing step S300 and the outside-air introduction increasing step S400, thus rapidly resolving a difference in pressure between the inside and outside of the vehicle due to the opening or tilting of the open part.

The method further includes a speed determining step S800 of determining that a driving speed is not equal to or above a predetermined speed in the state where the inside temperature is maintained within the predetermined temperature range by controlling the temperature of the outside air introduced via the temperature control door, and an initial driving step S900 that stops controlling the air conditioning device including the temperature control door if a difference in pressure between the inside and the outside is resolved when the driving speed is not equal to or above the predetermined speed, thus minimizing the air conditioning load.

Such a method for preventing inflow of exhaust gas for a vehicle according to an exemplary embodiment of the present invention controls the temperature control door of the air conditioning device when the outside air is introduced so as to resolve the difference in pressure between the inside and the outside during high speed driving, thus controlling the temperature of the air discharged to the inside, and thereby preventing the reentry of the exhaust gas while minimizing a change in the inside temperature, therefore maintaining the inside environment and offering pleasant air.

Meanwhile, the temperature measuring step S500 further includes a blowing step S600 of increasing the amount of air discharged to the inside by controlling the blower of the air conditioning device of the vehicle, when the outside temperature of the vehicle deviates from the predetermined temperature range.

At such a blowing step S600, the blower of the air conditioning device of the vehicle is operated to blow the outside air introduced through the inside/outside air door to the heater unit or the air conditioner unit of the air conditioning device, thus preventing the introduced outside air from being discharged to the inside without having been processed.

Further, if there is a large difference in temperature between the inside and outside of the vehicle, such as in an extremely cold or hot season, the extent to which the blower 500 is operated is increased, so that the amount of the air flowing into the heater unit 520 or the air conditioner unit 540 increases and thereby the inside temperature is controlled or maintained.

Meanwhile, at the temperature control step S700, if the temperature of the outside air is above the predetermined temperature range, the temperature control door is controlled to reduce the temperature of the air discharged to the inside. In contrast, if the temperature of the outside air is below the predetermined temperature range, the temperature control door is controlled to increase the temperature of the air discharged to the inside.

To be more specific, the temperature control door is controlled such that the air introduced via the blower passes through the heater unit if the temperature of the introduced outside air is below the predetermined temperature range, thus increasing the temperature of the air discharged to the inside. If the temperature of the outside air is above the predetermined temperature range, the temperature control door is controlled such that the air introduced via the blower passes through the air conditioner unit, thus reducing the temperature of the air discharged to the inside.

As described above, the present invention provides a system and method for preventing inflow of exhaust gas for a vehicle, which resolves a difference in pressure between an inside and an outside of the vehicle when it is being driven at high speed, thus preventing the exhaust gas from reentering the inside and thereby keeping the inside air pleasant.

Particularly, the present invention provides a system and method for preventing inflow of exhaust gas for a vehicle, which controls the temperature of air discharged to an inside when introducing outside air, thus improving the performance of heating or cooling the inside, and essentially preventing a driver from feeling unpleasant due to a change in temperature.

Further, the present invention provides a system and method for preventing inflow of exhaust gas for a vehicle, which controls an inside/outside air door to introduce an increased amount of outside air in the case where an open part is tilted or opened, as compared to the case where the open part is closed, when the vehicle speed is a predetermined speed or more, thus preventing inside pressure from rapidly escaping to an outside of the vehicle that is low in pressure, through the open part.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for preventing inflow of exhaust gas for a vehicle, comprising:
an inside/outside air door provided in an air conditioning device of the vehicle and controlling an amount of outside air introduced into an inside of the vehicle;
an outside-air temperature sensor measuring a temperature of the outside air of the vehicle;
a temperature control door disposed inside the air conditioning device of the vehicle and controlling a temperature of air discharged to the inside of the vehicle; and
a control unit controlling the inside/outside air door to cause an amount of the outside air to be introduced to the inside when a vehicle speed is equal to or larger than a predetermined speed,
wherein the control unit controls the temperature control door to control the temperature of the air discharged to the inside when the temperature of the outside air deviates from a predetermined temperature range.

2. The system as set forth in claim 1, wherein the temperature control door is disposed between a heater and an air conditioner and selectively diverts the air introduced to the air conditioner to the heater.

3. The system as set forth in claim 1, wherein a blower is disposed to fluid-communicate the outside air to the air conditioner.

4. The system as set forth in claim 1, further including:
a blower disposed inside the air conditioning device and controlling an amount of the air discharged to the inside of the vehicle,
wherein the control unit controls the blower when the vehicle speed is equal to or above the predetermined speed or the temperature of the outside air deviates from the predetermined temperature range, thus increasing the amount of the air discharged to the inside.

5. The system as set forth in claim 1, wherein the control unit controls the temperature control door when the temperature of the outside air is below the predetermined temperature range, thus increasing the temperature of the air discharged to the inside, the control unit reducing the temperature of the air discharged to the inside when the temperature of the outside air is above the predetermined temperature range.

6. The system as set forth in claim 5, wherein the control unit controls the temperature control door to guide the outside air to pass through the heater when the temperature of the outside air is below the predetermined temperature range, and the control unit controls the temperature control door to guide the outside air to pass through the air conditioner when the temperature of the outside air is above the predetermined temperature range.

7. The system as set forth in claim 1, wherein the control unit controls the inside/outside air door such that a larger amount of the outside air is introduced when an open part of the vehicle is tilted or opened, as compared to a case where the open part is closed.

8. A method for preventing inflow of exhaust gas for a vehicle, comprising:
a) detecting a vehicle speed;
b) introducing an increased amount of outside air by controlling an inside/outside air door in an air conditioning device of the vehicle when the vehicle speed is equal to or above a predetermined speed;
c) measuring a temperature of the outside air of the vehicle; and
d) controlling a temperature of air discharged to an inside by controlling a temperature control door in the air conditioning device of the vehicle when the temperature of the outside air of the vehicle deviates from a predetermined temperature range.

9. The method as set forth in claim 8, wherein b) step further includes:
sensing whether an open part of the vehicle is tilted or opened; and
introducing a larger amount of outside air than that of b) step, when the open part is tilted or opened.

10. The method as set forth in claim 8, after c) step, further including:
increasing an amount of air discharged to the inside by controlling a blower in the air conditioning device of the vehicle when the temperature of the outside air of the vehicle deviates from the predetermined temperature range.

11. The method as set forth in claim 8, wherein d) step includes:
increasing the temperature of the air discharged to the inside by controlling the temperature control door when the temperature of the outside air is above the predetermined temperature range; and
reducing the temperature of the air discharged to the inside when the temperature of the outside air is below the predetermined temperature range.

12. The method as set forth in claim 8, wherein d) step includes:
increasing the temperature of the air discharged to the inside by controlling the temperature control door to guide the outside air to pass through the air conditioner when the temperature of the outside air is above the predetermined temperature range, and
reducing the temperature of the air discharged to the inside air by controlling the temperature control door to pass through a heater when the temperature of the outside air is below the predetermined temperature range.
